(19) United States
(12) Patent Application Publication
(10) Pub. No.: US 2012/0102400 A1
(43) Pub. Date: Apr. 26, 2012

(54) Touch Gesture Notification Dismissal Techniques

(75) Inventors: Matthew Isaac Worley, Bellevue, WA (US); Tsz Yan Wong, Seattle, WA (US); Heiwad Hamidy Osman, Seattle, WA (US)

(73) Assignee: Microsoft Corporation, Redmond, WA (US)

(21) Appl. No.: 12/910,673

(22) Filed: Oct. 22, 2010

(51) Int. Cl. G06F 3/048; G06F 3/01

(52) U.S. Cl. 715/702; 715/809

(57) ABSTRACT

In an exemplary embodiment, touch input received by a computing device can be used to dismiss notifications. For example, a notification, e.g., a window including information about an event, can be displayed by a touch-screen. A user can touch touch-screen and dismiss the notification by performing a gesture. In addition to the foregoing, other aspects are described in the detailed description, claims, and figures.

### CROSS REFERENCE TO RELATED APPLICATION

This application is subject matter related to U.S. patent application Ser. No. ______ (Attorney Docket No. MVIR-0693/330618.01) entitled “Notification Group Touch Gesture Dismissal Techniques,” the contents of which is herein incorporated by reference in its entirety.

### BACKGROUND

A computing device, such as a tablet or the like, can run applications that may generate notifications. These notifications typically “pop” into view in a system tray or the like upon the occurrence of an event. For example, a notification for an email may be displayed in response to receipt of the email. These notifications may cover a part of the screen when they are displayed and may arrive when the user is not interested in shifting his or her attention from a current task. In a computing environment where the user has ample screen real estate, e.g., when the user has a monitor with 1920×1200 pixels and/or when the user has multiple monitors, these notifications may not interrupt the user and the user may simply wait for the notifications to be dismissed automatically, e.g., after 7 seconds, etc. On the other hand, when the computing environment is a tablet computer, e.g., a small computing device with a display resolution of, for example, 768×1024 pixels, the notification may cover real estate that is needed by the user. In the latter example, the user may want to dismiss the notification without having to interrupting his or her focus.

When the user is using an input device such as a mouse to interact with the computing device, the user may click on a small box with an “x” in the corner or the like to dismiss the notification. This technique works well for mice and styluses because the input is received at a specific coordinates; however, when touch input, e.g., input from a capacitive element such as a finger, is the input mechanism, is used the sensed input pattern is typically spread across multiple pixels and not concentrated on a single point. This makes it difficult for the computing device to determine whether or not the box was selected and may cause the user to shift his or her attention to the notification in order to dismiss it. Accordingly, techniques for easily dismissing notifications are desirable.

### SUMMARY

An exemplary embodiment includes a computing device. In this example, the computing device can include, but is not limited to a processor, a touch-screen, and a memory in communication with the processor when the computing device is operational. In this example, the memory can include computer readable instructions that upon execution cause the processor to display a first notification, wherein the first notification is visually decoupled from graphical user interface elements rendered by the touch-screen; display the first notification moving on the touch-screen based on first touch input sensed by the touch screen at coordinates associated with the first notification; and dismiss the first notification in response to determining that a threshold amount of the notification at least reached a boundary on the touch-screen and that the first touch input was removed from the touch-screen. In addition to the foregoing, other techniques are described in the claims, the detailed description, and the figures.

Another exemplary embodiment includes a method executed by a computing device. In an example, the method can include, but is not limited to displaying a first notification for an application event on a touch-screen; changing a position of the first notification based on first touch input at coordinates associated with the first notification sensed by the touch-screen; determining that the first touch input was removed from the touch-screen; and dismissing the first notification based at least on a velocity of the first notification in response to determining that the first touch input was removed from the touch-screen. In addition to the foregoing, other techniques are described in the claims, the detailed description, and the figures.

Another exemplary embodiment includes a computer-readable storage medium. In this example, the computer-readable storage medium includes, but is not limited to, instructions that upon execution by a processor of a computing device causes the computing device to: display an application event notification on a touch-screen at a first position; change the position of the application event notification based on first touch input sensed by the touch-screen at coordinates associated with the application event notification; determine that the first touch input was removed from the touch-screen; dismiss the application event notification in response to determining that a threshold amount of the notification passed a boundary of the touch-screen. In addition to the foregoing, other techniques are described in the claims, the detailed description, and the figures.

It can be appreciated by one of skill in the art that one or more various aspects of the disclosure may include but are not limited to circuitry and/or programming for effecting the herein-referenced aspects; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts a high-level block diagram of an exemplary computing device.

FIG. 2 depicts a high-level block diagram of a touch-interface of a touch-screen.

FIG. 3 depicts a high-level block diagram of an exemplary operating system 300.

FIG. 4 depicts a block diagram of computing device 100 configured to display and dismiss notifications.

FIG. 5 depicts a block diagram of computing device 100 configured to display and dismiss notifications.

FIG. 6 depicts an operational procedure.

FIG. 7 depicts an alternative embodiment of the operational procedure of FIG. 6.

FIG. 8 depicts an alternative embodiment of the operational procedure of FIG. 8.

FIG. 9 depicts an operational procedure.

FIG. 10 depicts an alternative embodiment of the operational procedure of FIG. 9.

FIG. 11 depicts an alternative embodiment of the operational procedure of FIG. 10.

FIG. 12 depicts an operational procedure.

FIG. 13 depicts an alternative embodiment of the operational procedure of FIG. 12.

### DETAILED DESCRIPTION

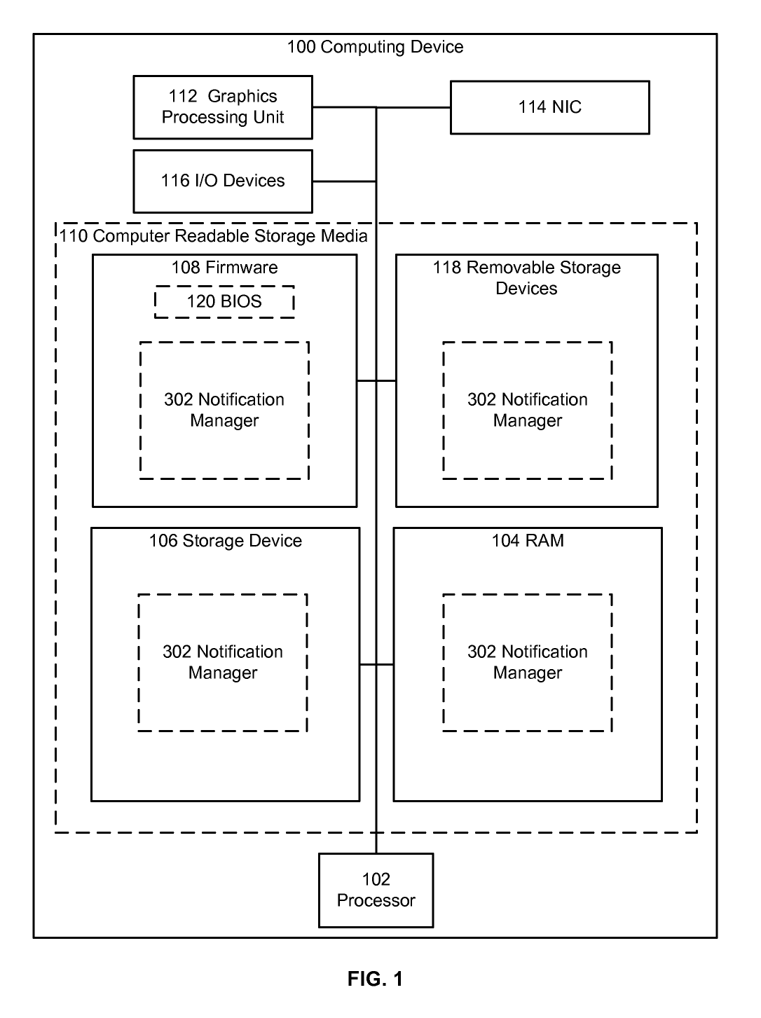

The disclosed subject matter may use a computing device such as a tablet computer. FIG. 1 and the following discussion are intended to provide a brief general description of a suitable computing environment in which the disclosed subject matter may be implemented.

The term circuitry used throughout can include hardware components such as hardware interrupt controllers, hard drives, network adaptors, graphics processors, hardware based video/audio codecs, and the firmware used to operate such hardware. The term circuitry can also include microprocessors, application specific integrated circuits, and processors, e.g., cores of a multi-core general processing unit that perform the operations of reading and executing instructions, configured by firmware and/or software. Processor(s) can be configured by instructions loaded from memory, e.g., RAM, ROM, firmware, and/or mass storage, embodying logic operable to configure the processor to perform a function(s). In an example embodiment, where circuitry includes a combination of hardware and software, an implementer may write source code embodying logic that is subsequently compiled into machine readable code that can be executed by hardware such as an application specific integrated circuit, processor, etc. Since one skilled in the art can appreciate that the state of the art has evolved to a point where there is little difference between hardware implemented functions and software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary computing device 100 is depicted. Computing device 100 can include processor 102, e.g., an execution core. While one processor is illustrated, in other embodiments computing device 100 may have multiple processors, e.g., multiple execution cores per processor substrate and/or multiple processor substrates that could each have multiple execution cores. As shown by the figure, various computer-readable storage media 110 can be interconnected by one or more system busses which couples various system components to the processor 102. The system buses may be any of several types of bus structures including a memory bus or memory controller, a peripheral bus, and a local bus using any of a variety of bus architectures. Computer-readable storage media 110 can include, but is not limited to, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media can be used such as magnetic cassettes, flash memory cards, and/or digital video disks. As shown by FIG. 1, notification manager 302, which is illustrated in dashed-lines, can be stored in RAM 104, storage device 106, firmware 108, and/or removable storage devices 118. Notification manager 302, can be executed by processor 102 thereby transforming computing device 100 into a machine configured to effect aspects disclosed in the following paragraphs.

The computer-readable storage media 110 can provide non volatile and volatile storage of executable instructions, data structures, program modules and other data for the computer 100 such as executable instructions. A basic input/output system (BIOS) 120, containing the basic routines that help to transfer information between elements within the computing device 100, such as during start up, can be stored in firmware 108. A number of programs may be stored on firmware 108, storage device 106, RAM 104, and/or removable storage devices 118, and executed by processor 102 including an operating system and/or application programs.

Commands and information may be received by computing device 100 through input devices 116 which can include, but are not limited to, a keyboard and pointing device. Other input devices may include a microphone, joystick, game pad, scanner or the like. These and other input devices are often connected to processor 102 through a serial port interface that is coupled to the system bus, but may be connected by other interfaces, such as a parallel port, game port, or universal serial bus (USB). A touch-screen or display device can also be connected to the system bus via an interface, such as a video adapter which can be part of, or connected to, a graphics processor unit 112.

Computing device 100 may operate in a networked environment using logical connections to one or more remote computers, such as a remote computer. The remote computer may be another computer, a server, a router, a network PC, a peer device or other common network node, and typically can include many or all of the elements described above relative to computing device 100.

When used in a LAN or WAN networking environment, computing device 100 can be connected to the LAN or WAN through network interface card 114. The NIC 114, which may be internal or external, can be connected to the system bus. In a networked environment, program modules depicted relative to the computing device 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

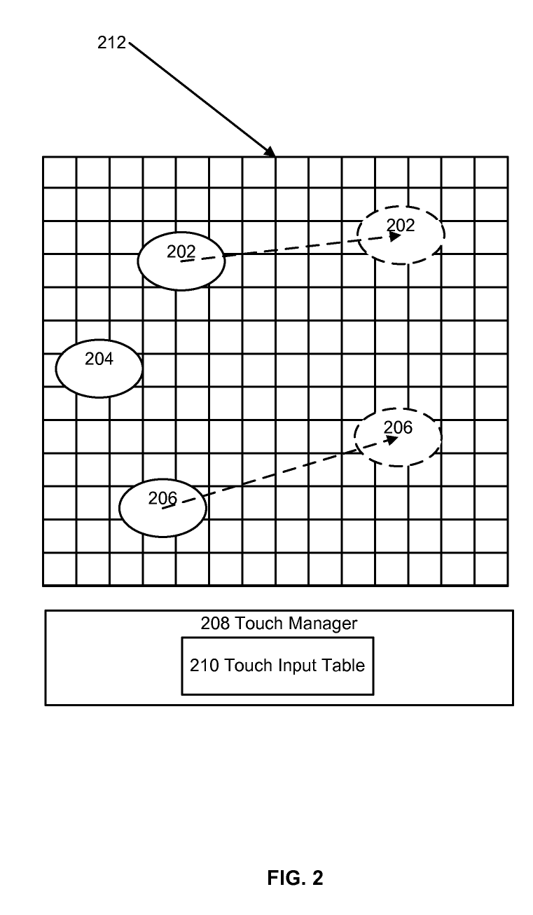

Referring now to FIG. 2, it illustrates a top-down view of exemplary touch-screen 200. Touch-screen 200 can be integrated with computing device 100 described above with respect to FIG. 1 and be used to receive user input from a user. In an exemplary configuration, touch-screen 200 can be configured to allow a user to use multiple capacitive elements, e.g., fingers, to simultaneously interface with touch-screen 200. Touch-screen 200 be formed from multiple layers such as a protective layer, a glass substrate, and a LCD display layer. Briefly, the protective layer protects touch-screen 200 from damage and the LCD display layer is configured to render images on touch-screen 200. Capacitive layer 212, which is described in more detail in the following paragraphs, can be deposited between the glass substrate and the protective layer by a bonding layer.

In an exemplary embodiment, capacitive layer 212 can be formed by a mutual capacitance system. In this example, the mutual capacitance system can comprise a grid formed from two layers of material: columns of sensing lines, which can detect current at nodes (the intersection between a row and a column) and rows of driving lines, which carry current (one skilled in the art can appreciate that the driving lines could be implemented as columns and vertical the sensing lines could be implemented as rows in alternative embodiments). In this example, capacitors can be positioned at the intersection of each node and voltage can be applied to the columns. When a finger or other capacitive element touches touch-screen 200, the line carrying the voltage comes into contact with the row, a current will flow; and a signal can be sent to touch manager 208.

In another embodiment, the capacitive layer 212 can be formed from a self capacitance system. In this example, transparent electrodes may be positioned in rows and columns so as to form a grid. When a finger of other capacitive element touches touch-screen 200 the touched electrodes measure the capacitance and generate a signal that is sent to touch manager 208.

When touch input, such as input from a finger, is sensed by touch-screen 200 a signal can be sent touch manager 208, which can determine the position of the touch input. For example, touch manager 208, which can be a module of executable instructions, can execute and analyze the signals to determine the size, shape, and location of the of the touch input. This information could be stored in touch input table 210 and associated with an identifier, e.g., touch input 202. As the user moves his or her finger across touch-screen 200, touch manager 208 receives data from the capacitive layer 212; determines which touch input the data is associated with, e.g., touch input 202, and stores coordinates associated with touch input 202 in touch input table 210. In the instance that the user removes his or her finger from touch screen 200, touch manager 208 can determine that a gesture, e.g., touch input 202 has ended.

As shown by the figure, in an exemplary embodiment touch input from multiple sources can be simultaneously tracked. For example, a user may touch touch-screen 200 with three fingers and touch manager 208 can receive at least three signals from capacitive layer 212. In this example, touch manage 208 can detect three distinct locations and determine that three touch inputs 202, 204, and 206 have been received. Touch manager 208 can be configured to store identifiers for each touch input in touch input table 210 and track how touch inputs 202, 204, and 206 change.

As a user makes a gesture with his or her fingers by moving them up and to the right touch manager 208 can track the coordinates of touch input 202, and 206 and use the data to generate one or more touch-messages, which can be sent to processes such as notification manager 302. Touch-messages can include information such as an identification of the type of event, e.g., touch-received or touch-removed, a timestamp for the event, the difference between the current location of the event and a previous location of the event, the coordinates for the event, an identifier for the touch input, etc.

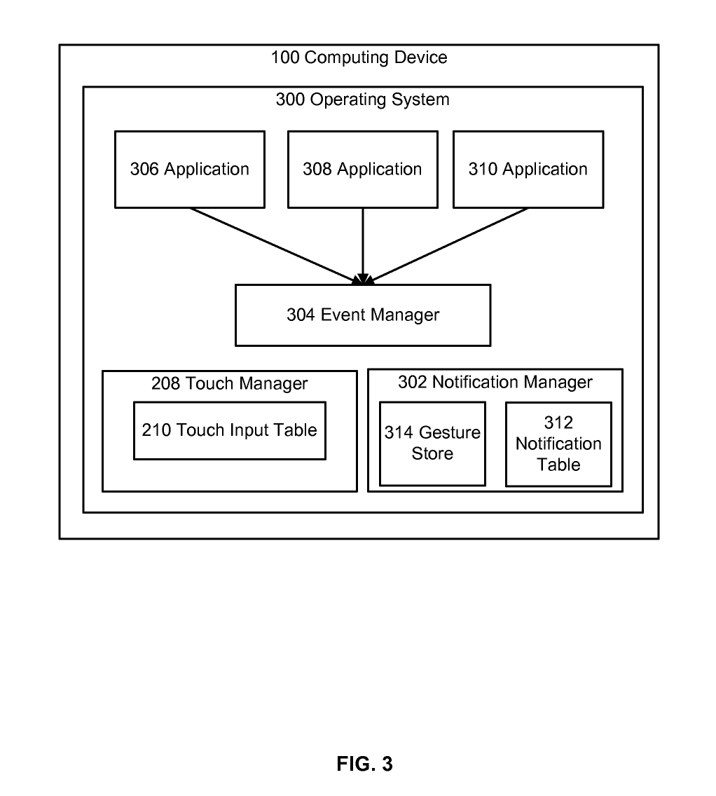

Turning now to FIG. 3, it illustrates a block-diagram of an exemplary operating system 300 that can be stored in memory of computing device 100 and executed by processor 102. As shown by FIG. 3, operating system 300 can include touch manager 208 described above with respect to FIG. 2, one or more applications 306, 308, and 310, which can be applications such as instant messenger programs, email applications, or any other program that can request a notification in response to the occurrence of an event, an event manager 304, and a notification manager 302.

The arrows flowing from applications 306-310 to event manager 304 signify that one or more applications can register with event manager 304 to have event manager 304 display notifications on touch-screen 200. After the applications register with event manager 304, event manager 304 can wait until it receives a signal indicative of an event from an application. In an exemplary embodiment, the notifications can be toast notifications. Briefly, a toast notification is a small notification that can slide into view from the bottom, top, or side of touch-screen 200. In response to the signal, event manager 304 can generate a notification, e.g., a window including text associated with the notification, and send a request to display the notification to notification manager 302.

Notification manager 302, which can be one or more modules of executable instructions, can be configured to receive requests from event manager 304; cause notifications to be rendered by touch-screen; change the position of rendered notifications; and dismiss notifications. In the following paragraphs, notification manager 302 is described as using touch input to manipulate messages; however, the disclosure is not limited to using touch and notification manager 302 can use input messages from any type input device, e.g., touch, mouse, keyboard, joystick, etc. In these alternative embodiments, notification manager 302 can be configured to process messages from these other input devices and the information contained therein, e.g., coordinates, timestamps, etc., in the same way that touch-messages are used.

Returning to the description of FIG. 3, notification manager 302 can create an entry for the notification in notification table 312 and determine initial coordinates to display the notification in response to receiving requests to display a notification. In an exemplary embodiment, the coordinate system can be measured in units of pixels, where each pixel is described by a x and y coordinate pair. In an exemplary configuration, the x-coordinates can increase to the right and the y-coordinates can increase going from the top to the bottom. The origin (0,0) depends on the type of coordinates being used and can be the upper-left corner of touch-screen 200 in an exemplary embodiment. In this example, notification manager 302 can store the pixel pair values for the upper-left corner of the notification and the lower-right corner of the notification in notification table 312.

Notification manager 302 can be configured to select coordinates for the notifications that cause notifications to slide in from the right-side of touch-screen 200 into the lower right-hand corner of touch-screen 200 and subsequent notifications to slide in above prior notifications (one of skill in the art can appreciate that notifications can be displayed at any location by notification manager 302 and the disclosure is not limited to displaying notifications in the lower-right hand corner of touch screen 200 or having them slide in from the right). In a specific example, the notifications can be rendered so they look as if they slid into view from off-screen over the window that currently has the focus. In this specific example, the notification are visually decoupled other graphical user interface element currently displayed such that they appear to be discrete elements unassociated with other rendered images. Or put another way, the notification can be separate from any other element, e.g., task bar, application, notification folder, etc., displayed on touch-screen 200, thus appearing as if they are not attached to any other image being rendered by touch-screen 200. For example, if a desktop was being displayed the notification could slid in from the top, bottom, or side and be overlaid on top of the desktop. Similarly, if an Internet browser was open and had the current focus, the notification could slide from the top, bottom, or side and be overlaid on top of the Internet browser.

At this point, a user has a choice: the user can select the notification, wait for the notification to be automatically dismissed, or dismiss the notification him or herself. In the instance that the user wishes to dismiss the notification, the user can dismiss the notification by performing a dismissal gesture. In an exemplary embodiment, information for one or more dismissal gestures can be stored in gesture store 314 and used to determine if the user is trying to dismiss a notification.

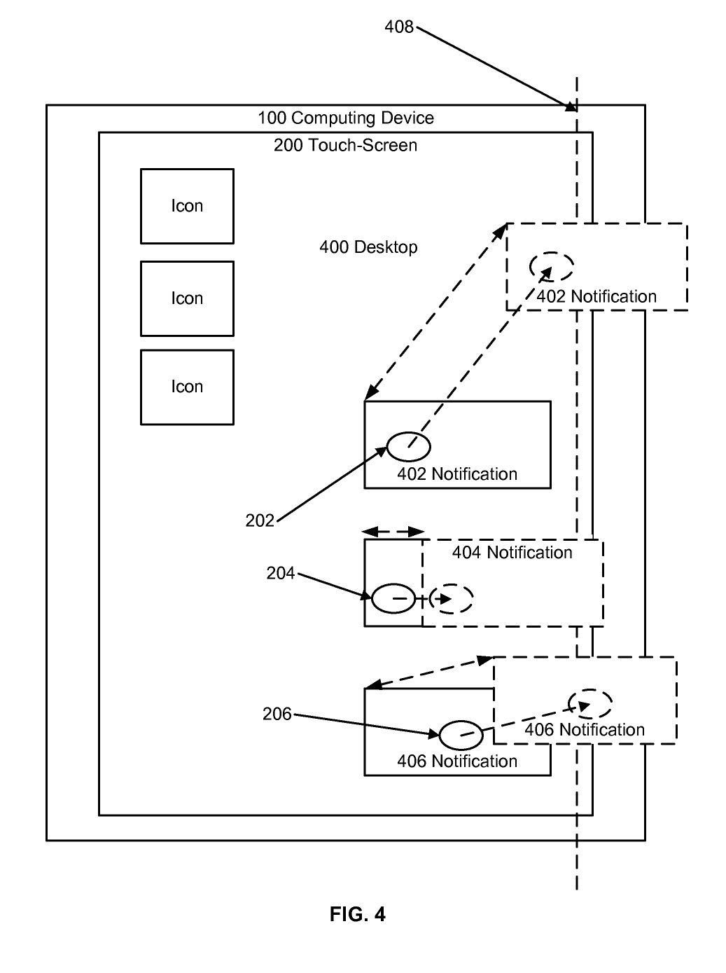

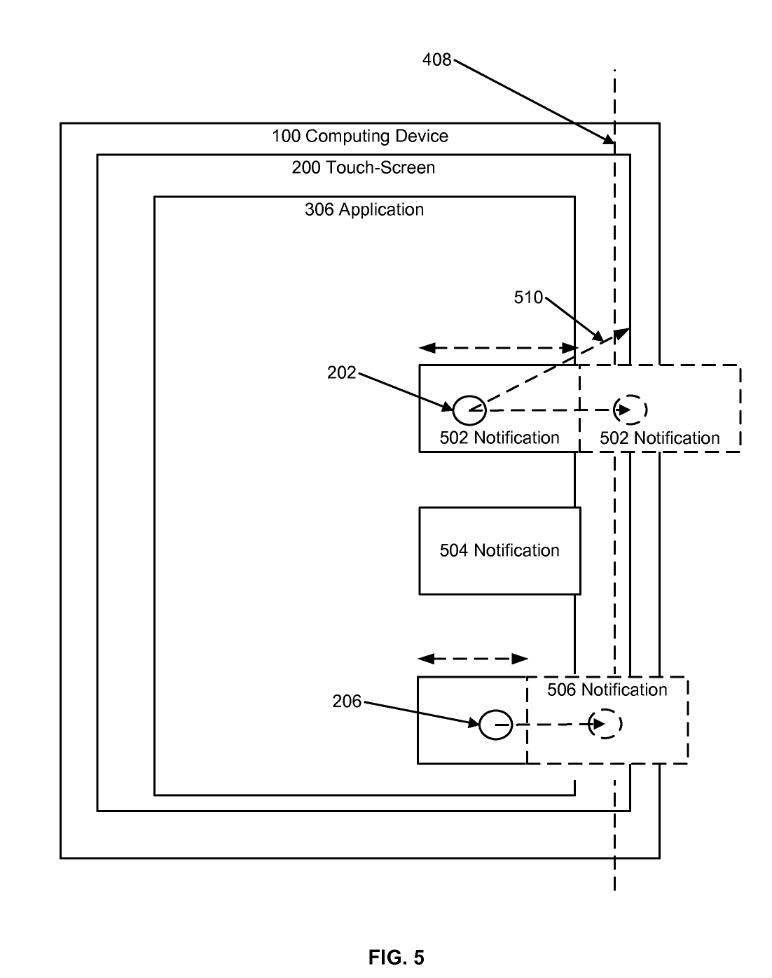

Referring to FIG. 4 and FIG. 5, these figures illustrate different dismissal gestures that could be used to dismiss gestures. Touch-screen 200 can render images indicative of, for example, desktop 400 along with icons for applications, files, etc., and one or more notifications such as notification 402, 404, and 406, which can be overlaid on top of desktop 400. FIG. 5 shows a similar environment, except that in this illustrated environment, user interface for application 306, e.g., an Internet browser, can be displayed by touch-screen 200 and the movement of notifications 502, 504, and 506, can be limited to moving along the x-axis. For example, an implementer may not want to allow users to move notifications every which way and limit movement to one dimension. Briefly, the notifications in solid lines indicate exemplary initial positions for the notifications and notifications in dashed lines illustrate how the notifications could be moved. The ovals in solid lines indicate exemplary coordinates where touch input are sensed, the dashed ovals indicate how the touch input could change over time, and the dashed arrows show the path the touch input could take.

Turning back to the description of notification manager 302, in an exemplary embodiment a dismissal gesture can be based on the location of the notification when it is released by the user. Or put another way, notification manager 302 can determine that a dismissal gesture has been performed based on the position of the notification when a touch-message is received that indicates that the associated touch-input was removed from touch-screen 200. In this example, gesture store 314 could include a threshold such as a percentage, e.g., 25%, and a boundary. In this example, notification manager 302 can use the threshold to dismiss notifications by dismissing notifications that are 25% passed a boundary such as boundary 408, which can be used to determine whether or not to dismiss notification. In this example, notification manager 302 can be configured to dismiss notifications when a threshold amount of the notification is passed boundary 408 when touch input is removed.

Boundary 408 can be a coordinate such as an x-coordinate set by an implementer. For example, boundary 408 can be the last pixel value for touch-screen 200, e.g., pixel value 768 in an embodiment where computing device has a resolution of 768×1024 and is being held so the smaller dimension is the lengthwise dimension, e.g., the orientation illustrated by FIG. 4. In other exemplary embodiments, boundary 408 can be set to be a value less than the max pixel value such as the embodiment illustrated by FIG. 4 and FIG. 5.

In this exemplary embodiment, suppose notification 402 has been moved from its initial position (the position indicated in solid lines) to the release position (the position indicated in dashed lines). In this example, notification manager 302 can calculate the amount of notification 402 that passed boundary 408 and compare the calculated value to the threshold stored in gesture store 314. In one instance, the threshold can be area based, e.g., the area of threshold that has passed boundary 408 can be calculated and compared to a threshold. In another embodiment, the threshold can be one dimensional, e.g., an x or y component can be used to calculate the amount of notification 402 that passed a boundary. For example, in the instance that boundary 408 is a horizontal boundary (such as is shown by the figure) notification manager 302 can calculate the x-component portion of notification 402 that passed boundary 408 from the x-coordinate that represents the position of the upper-left corner of notification 402, the x-coordinate that represents the position of the lower-right corner of notification 402, and boundary x-coordinate from gesture store 314. This value can then be compared to a threshold.

In the instance that the calculated amount is larger than the threshold, notification manager 302 can determine that notification 402 passed the threshold and dismiss notification 402. As shown by the dashed arrow pointing back to the initial position of notification 402, in the instance that the value is less than the threshold, notification manager 302 can cause touch-screen 200 to move notification 402 back to its initial position.

In another example embodiment, other dismissal gestures can be used to dismiss notifications. For example, a dismissal gesture can be based on the position of the touch input when the user releases his or her finger. In this example, gesture store 314 can store boundary 408 and notification manager 302 can be configured to dismiss selected gestures in the instance that touch input reached and/or passed boundary 408. In this example, suppose touch-screen 200 is rendering a series of images that show notification 406 moving along with the user's finger as he or she moves it from its initial position to the position illustrated in dashed lines in FIG. 4. In this example, when notification manager 302 receives a touch-message that indicates that the user removed his or her finger, notification manager 302 can check notification table 312 to retrieve the last coordinates of touch input 206 and compare them to boundary 408. In the instance that the x-coordinate of touch input 206 is equal to or greater than boundary 408, then notification manager 302 can dismiss selected notifications, e.g., notification 406. As shown by the dashed arrow pointing back to the initial position of notification 406, in the instance that the value is less than the threshold, notification manager 302 lookup the initial coordinates of notification 406 and can cause touch-screen 200 to render one or more images of notification 406 moving back to its initial position.

In the same or another exemplary embodiment, a dismissal gesture can use the velocity of a notification and/or or the velocity of the touch input to dismiss notifications. For example, notification manager 302 can be configured to dismiss notifications when velocity of a notification and/or the touch input is greater than a threshold velocity at the moment that touch input is removed from touch-screen 200. In this example, gesture store 314 can be configured to include a velocity threshold, e.g., a value, and a directional component that can be compared to the current velocity and direction of a notification, e.g., 402 when touch input is removed from touch-screen 200. In the instance that the current velocity of the notification is less than the threshold velocity or the velocity in the wrong direction, notification manager 302 can cause an animation to be rendered on touch-screen 200 that shows the notification returning to its initial position. In the instance that the current velocity of the notification is greater than the threshold and the velocity is in the correct direction, notification manager 302 can use the current coordinates of the notification and the vector of the notification to cause touch-screen 200 render a series of images showing the notification moving off-screen in the direction of the vector.

As shown by the figure, in exemplary embodiments multiple notifications may be simultaneously displayed by touch-screen 200. In an exemplary embodiment, each notification can be individually selectable and dismissible. Or put another way, notification manager 302 can separately track each notification and determine whether or not to dismiss each notification on an individual basis by comparing its associated touch input to a dismissal gesture. For example and referring to FIG. 4, as shown by the figure, a user may manipulate all three notifications 402, 404, and 406 and when the user releases the notifications notification manager 302 can individually determine whether or not to dismiss each notification.

The following are a series of flowcharts depicting operational procedures. For ease of understanding, the flowcharts are organized such that the initial flowcharts present implementations via an overall “big picture” viewpoint and subsequent flowcharts provide further additions and/or details that are illustrated in dashed lines.

Turning now to FIG, 6, it illustrates an operational procedure including operations 600, 602, 604, and 606. As shown by the figure, operation 600 begins the operational procedure and operating 602 shows that in an embodiment computing device 100 can include circuitry for displaying a first notification, wherein the first notification is visually decoupled from graphical user interface elements rendered by the touch-screen. For example, touch-screen 200 can be configured to display a first notification. In this example, the first notification could be visually decoupled from other graphical user interface elements that have been rendered by touch-screen 200. For example, computing device 100 can include touch-screen 200, which can be configured to sense touch input from, for example, a finger of a user. In this example, computing device 100 can include an event manager 304, which can be configured to receive requests to display notifications from applications such as an instant messenger client. Event manager 304 can receive requests to display notifications and communicate the same to notification manager 302, which can cause touch-screen 200 to render images indicative of at least a first notification. In this example, the notification 302 can be visually separated from other elements rendered by touch-screen 200, e.g., the notification can appear as if it is not connected to a folder, a desktop, a task bar, a system tray, etc. Instead, the notification could appear to slide on-screen from the side, bottom, or top and look as if it is on top of other elements rendered by touch-screen 200.

In a specific example, and referring to FIG. 4, in response to receiving a request to display a notification, notification manager 302 can store an identifier indicative of a notification, e.g., notifications 402 in notification table 312; and determine an initial position for the notification, e.g., an initial position for the upper-left corner of the notification in the lower-right corner of touch-screen 200, and send commands to operating system 300 indicative of a request to render images indicative of notification 402 sliding onto touch-screen 200 from the right side to its initial position.

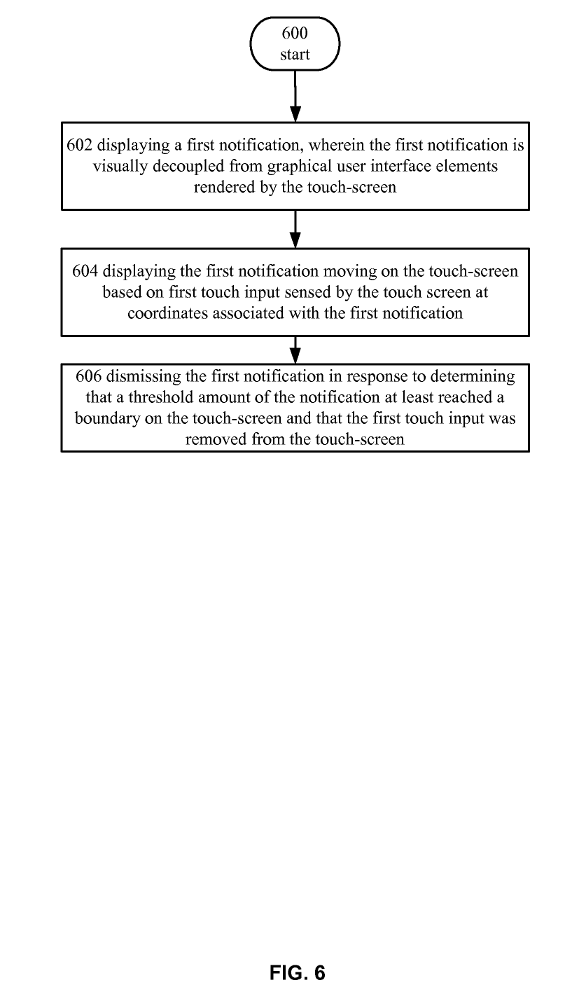

Continuing with the description of FIG. 6, operation 604 shows displaying the first notification moving on the touch-screen based on first touch input sensed by the touch screen at coordinates associated with the first notification. For example, and referring to FIG. 4, in an exemplary embodiment the position of the first notification, e.g., notification 402, can be changed based on touch input, e.g., touch input 202, by notification manager 302 causing touch-screen 200 to render images of the notification being moved along with touch input 202. In this exemplary embodiment, notification manager 302 can be configured to change the position of notification 402 in response to sensed touch input from, for example, a digit of a user. For example, and referring to FIG. 4, notification manager 302 can cause the image of notification 402 to change to appear as if it is moving up and to the right to an updated position, e.g., the dashed element labeled notification 402. Alternatively, and referring to FIG. 5, notifications may limited to being moved in one dimension such as horizontally.

Notification manager 302 can cause the position of an image indicative of notification 402 to be changed based on coordinates indicative of the position where touch input 202 is sensed. For example, notification manager 302 can include notification table 312, which can include a column that includes identifiers for each notification it is currently tracking, e.g., identifiers for notification 402, 404, and/or 406, columns that store the coordinates of, for example, the initial position of each notification (402, 404, and/or 406), and coordinates of the current position of each notification (402, 404, and/or 406), a column that includes an identifier for the touch source associated with a notification, e.g., an identifier indicating that touch input 202 is associated with notification 402, etc. In this specific example, notification manager 302 can receive a touch-message that includes an identifier for touch input 202 and the difference between its current sensed position and a previous sensed position. In this example, notification manager 302 can determine that notification 402 is associated with touch input 202 and update the coordinates of the current position of notification 402 based on the difference and send a signal to touch-screen 200 to cause touch-screen 20 render one or more images of notification 402 moving to the updated position.

Referring back to FIG. 6, operation 606 shows that in an embodiment computing device 100 can include circuitry for dismissing the first notification in response to determining that a threshold amount of the notification at least reached a boundary on the touch-screen and that the first touch input was removed from the touch-screen. In an exemplary embodiment, the amount of the first notification that has been moved passed a boundary can be used to determine if a dismissal gesture was performed. For example, gesture store 314 can include a value indicative of the amount of a notification as a dismissal threshold. In this example, when touch input is removed from touch-screen 200, notification manager 302 can determine how much of the first notification has been moved passed the boundary and compare the amount to the threshold. In the instance that the amount of the first notification that has passed the boundary is greater than the threshold, notification manager 302 can be configured to dismiss the notification. For example, notification manager 302 can determine a path for the notification that would move the notification off-screen, e.g., off the right side of touch-screen 200, and cause touch-screen 200 to render one or more images showing the notification moving off-screen according to the path.

In a specific example, and referring to FIG. 4, suppose notification manager 302 has changed the position of notification 406 to move a part of it passed a boundary, which could be the last x-coordinate on touch-screen 200, e.g., pixel value 768. That is, touch-messages indicating that touch input 202 has moved up and to the right can be received by notification manager 302, which can cause touch-screen 200 to change the position of notification 402 to make it appear to move up and to the right. In this example, the user may release notification 402 and a touch-message can be received by notification manager 302 that indicates that touch input 202 has been removed. Notification manager 302 can deselect notification 402 and compare that the part of notification 402 that has moved passed pixel 768 to a threshold. In response to this determination, notification manager 302 can cause touch-screen 200 to dismiss notification 402.

In an exemplary embodiment, the threshold can be based on the area of the notification, the horizontal off-screen component, or the vertical off-screen component. For example, in an embodiment where area is used, notification manager 302 can be configured to determine the area of the notification that has passed the boundary using information that describes the amount of pixels in the touch-screen 200, the coordinates of the upper-left corner of the first notification, and the lower-right corner when touch input 202 was removed.

In another embodiment, the x-coordinates of notification 402 can be used. For example, the horizontal component of the coordinates that identify the position of the first notification, e.g., the coordinates associated with the upper-left corner and the lower-right corner, and the x-coordinate identifying the last pixel for touch-screen 200 can be used to determine the horizontal component that has passed boundary.

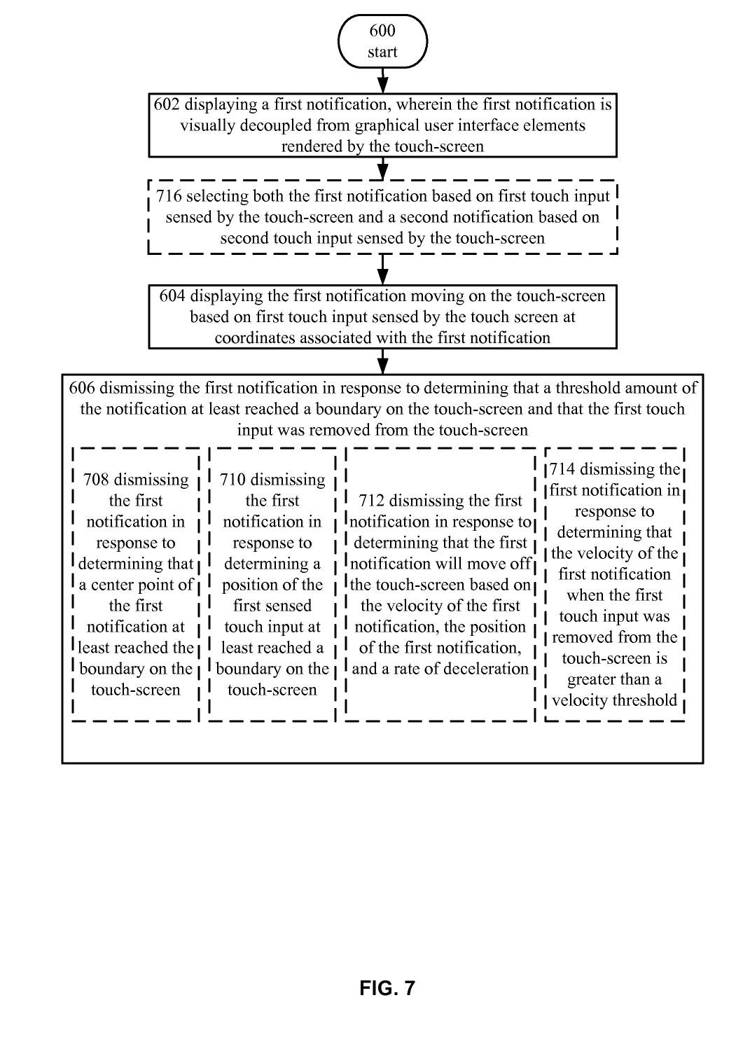

Turning to FIG. 7, it illustrates additional operations/refinements that can be executed along with those described with respect to FIG. 6. The additional operations/refinements are illustrated in dashed lines to indicate that these operations/refinements are considered optional.

Referring to operation 708, it illustrates that in an embodiment computing device 100 can include circuitry for dismissing the first notification in response to determining that a center point of the first notification at least reached the boundary on the touch-screen. In an exemplary embodiment, a center point of the notification can be compared to the boundary to determine whether or not to dismiss the notification.

For example, notification manager 302 can receive a message that indicates that touch input 202 was removed from touch-screen 200 and determine that touch input 202 was associated with notification 402. In response to this determination, notification manager 302 can determine that a center point of notification 402, e.g., a center point calculated from x, y coordinates of the upper-left corner of notification 402 and x, y coordinates of the lower-right corner of notification 402, and compare the center point of notification 402 to a boundary, e.g., a pixel value which could be an x, y, coordinate pair, an x coordinate, or a y coordinate, and determine if the center point has moved to and/or passed the boundary. In the instance that the center point of notification 402 has reached and/or passed the center point, notification manager 302 can be configured to dismiss notification 402 by determining a path for notification 402 to travel to move off-screen and causing touch-screen 200 to render one or more images of notification 402 moving off-screen according to the path.

In a specific example embodiment, and referring to FIG. 5, suppose notification manager 302 has limited the motion of notifications to moving in the horizontal direction, i.e., on the x-axis. Notification manager 302 can determine a location of a horizontal center point, which could be calculated from the current position of upper-left corner x-coordinate and the current position of the x-coordinate associated with the lower-right corner and the determined location of the center point can be compared to an x-coordinate of boundary 408, which could be the edge of touch-screen 200. In the illustrated example, the horizontal center point of notification 502 can be determined to have passed boundary 408. In response to this determination, notification manager 302 can be configured to dismiss notification 502 by determining a path for notification 502 to travel off-screen and cause touch-screen 200 to render one or more images of notification 502 moving off-screen according to the path.

Turning to operation 710, it shows that in an embodiment computing device 100 can include circuitry for dismissing the first notification in response to determining a position of the first sensed touch input at least reached a boundary on the touch-screen. For example, notification manager 302 can be configured to dismiss notifications in the instance that touch input associated with the notifications was sensed at and/or passed boundary 408 of touch-screen 200 when the touch input was removed his or her finger from touch-screen 200.

For example, and referring to FIG. 4, notification manager 302 may have stored information in notification table 312 that indicates that notification 402 has been selected by touch input 202. For example, the user may have placed his or her finger on touch-screen 200 within coordinates associated with notification 402 and dragged his or her toward the right side of touch-screen 200. In this example, the user may move his or her finger to and/or passed boundary 408, which could be set to the last pixel for touch-screen 200, e.g., pixel value 768 (in an embodiment where touch-screen has 768×1024 pixels), or to an x-coordinate before the edge, e.g., pixel value 758, etc. The user may then remove his or her finger from touch-screen 200 and notification manager 302 may receive a touch-message that indicates that touch input 202 has been removed from touch-screen 200. In this example, notification manager 302 can access table 312 and obtain coordinates for touch input 202 from a prior sample and determine that the x-coordinate of touch input 202 is equal to or greater than the x-coordinate of boundary 408, which could be obtained from gesture store 314. In response to this determination, notification manager 302 can check notification table 312 to determine if any notifications were associated with touch input 202. Notification manager 302 can determine that notification 402 is associated with touch input 202 and dismiss notification 402 by determining a path for notification 402 to travel off-screen and causing touch-screen 200 to render one or more images of notification 402 moving off-screen in accordance with the determined path.

Continuing with the description of FIG. 7, operation 712 shows that in an embodiment computing device 100 can include circuitry for dismissing the first notification in response to determining that the first notification will move off the touch-screen based on the velocity of the first notification, the position of the first notification, and a rate of deceleration. For example, in an embodiment a notification can be dismissed in the instance that notification manger 302 calculates that the notification would move off-screen based on the velocity of the notification when touch input it is associated with is removed from touch screen 200, the coordinates of the notification when touch input it removed, and a rate of deceleration. For example, notification manager 302 can calculate the initial velocity of a notification from at least two touch-messages that include the coordinates of the upper-left corner of the notification when touch input was removed, coordinates of the upper-left corner of the notification from a previous sample, and timestamps from the touch-messages. The rate of deceleration in this example can be a constant that can be set by an implementer.

In this example, notification manager 302 can calculate the coordinates at which the velocity would be equal to zero. In this example, if the coordinates are beyond the boundary, notification manager 302 can cause touch-screen 200 to render one or more images of the notification moving off-screen. In the instance that coordinates are not passed the boundary, notification manager 302 can cause touch-screen 200 to render one or more images of the notification moving back to its initial position. In this example, the animation could show the notification slowing down and pausing at the coordinates where the final velocity would be zero and then moving back to its initial position. In the instance that coordinates are at the edge, an implementer can either have the notification return to its initial position, have it move off-screen, or have it pause at the edge to allow the user to touch the notification and move it off-screen, e.g., notification manager 302 can have the notification pause to give the user time to give the notification one more push to get it off-screen.

Turning now to operation 714, it shows that in an embodiment computing device 100 can include circuitry for dismissing the first notification in response to determining that the velocity of the first notification when the first touch input was removed from the touch-screen is greater than a velocity threshold. In an exemplary embodiment, the release velocity of the notification can be used to determine if a dismissal gesture was performed. For example, gesture store 314 can include a release velocity threshold. In this example, when touch input is removed from touch-screen 200, notification manager 302 can determine the velocity of the first notification and compare the velocity of the first notification to a threshold. In the instance that the velocity is greater than the velocity threshold, notification manager 302 can be configured to dismiss the selected notifications associated with touch input 202. For example, notification manager 302 can determine a path for the notifications that would move the notifications off-screen, e.g., off the right side of touch-screen 200, and cause touch-screen 200 to render one or more images showing notifications in the group moving off-screen according to the path.

In a specific example, and referring to FIG. 5, notification 502 may be selected and the user may move his or her finger towards the right edge of touch-screen 200 making a “flicking motion,” and remove his or her finger from touch-screen 200. In response, touch-manager 208 can receive one or more signals from capacitive layer 212 of touch-screen 200 indicating that touch input 202 made a quick motion and then ended. Touch-manager 208 can process this information and generate one or more touch-messages and send them to touch manager 302. Touch manager 302 can determine the velocity of touch input 202 by using the change in position between two points, e.g., from coordinates associated with the last two touch-messages for touch input 202, and timestamps. Notification manager 302 can compare the calculated velocity to the threshold and determine if the calculated velocity is higher. In the instance it is higher, notification manager 302 can dismiss notification 502.

Continuing with the description of FIG. 7, operation 716 shows that in an embodiment computing device 100 can include circuitry for selecting both the first notification based on first touch input sensed by the touch-screen and a second notification based on second touch input sensed by the touch-screen. In an exemplary embodiment, notification manager 302 can store information in notification table 312 indicating that the first notification has been selected. For example, notification manager 302 can receive a touch-message that includes coordinates from a first touch input, e.g., touch input 202, and determine that the coordinates are within coordinates associated with the first notification. At the same time, or shortly thereafter, notification manager 302 can receive a touch-message that includes coordinates from a second touch input source, e.g., touch input 204, and determine that the coordinates are within coordinates associated with the second notification. Notification manager 302 can store information in notification table 312 indicating that the second notification has been selected by touch input 204.

In a specific example, first touch input can be sensed at a position on touch-screen 200 within the first notification and touch-screen 200 can send a signal to touch manager 208. Touch manager 208 can determine that this touch input is from a new source (based on a lack of prior touch input being sensed) and determine the coordinates for the touch input, e.g., x, y coordinates that are within the x, y coordinates that define the initial location of the first notification. Touch manager 208 can generate a touch-message including an identifier for touch input 202, a timestamp, and the coordinates for touch input 202 and send the message to notification manage 302. Notification manager 302 can receive the message and compare the coordinates for touch input 202 to coordinates of the first notification and determine that touch input 202 is within the first notification. Notification manager 302 can store information identifying that the first notification has been selected and information that identifies the touch input 202 in notification table 312.

Sometime later, e.g., 1 second later, second touch input can be sensed at a position on touch-screen 200 within the second notification and touch-screen 200 can send a signal to touch manager 208. Touch manager 208 can determine that this touch input is from a second source (based on information that identifies touch input 202 at a different location) and determine the coordinates for the second touch input, e.g., x, y coordinates that are within the x, y coordinates that define the initial location of the first notification. Touch manager 208 can generate a touch-message including an identifier for touch input 204, a timestamp, and the coordinates for touch input 204 and send the message to notification manage 302. Notification manager 302 can receive the message and compare the coordinates for touch input 204 to coordinates of the second notification and determine that touch input 204 is within the first notification. Notification manager 302 can store information identifying that the second notification has been selected and information that identifies the touch input 204 in notification table 312.

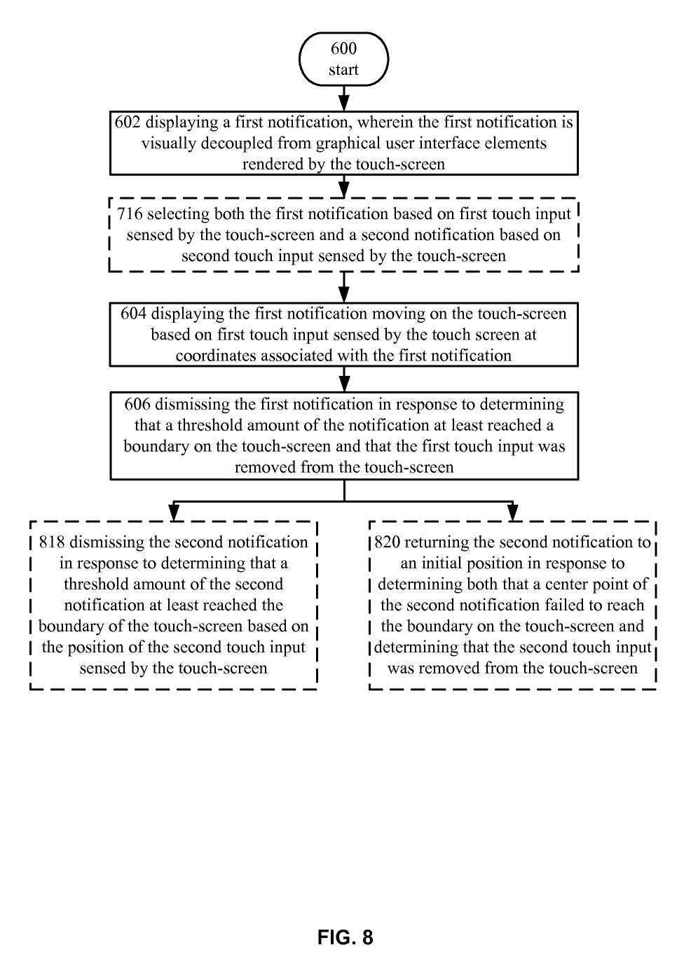

Referring now to FIG. 8, it illustrates additional operations that can be performed in exemplary embodiments. For example, operation 818 illustrates that in an embodiment computing device 100 can include circuitry for dismissing the second notification in response to determining that a threshold amount of the second notification at least reached the boundary of the touch-screen based on the position of the second touch input sensed by the touch-screen. In an exemplary embodiment, the amount of the second notification, e.g., notification 404, that has been moved passed boundary 408 can be used to determine if a dismissal gesture was performed. For example, gesture store 314 can include a value indicative of the amount of a notification as a dismissal threshold. In this example, when touch input is removed from touch-screen 200, notification manager 302 can determine how much of notification 404 has been moved passed boundary 408 and compare the amount to the threshold. In the instance that the amount of notification 404 that is passed boundary 408 is greater than the threshold, then notification manager 302 can be configured to dismiss the notification. For example, notification manager 302 can determine a path for notification 404 that would move the notification off-screen, e.g., off the right side of touch-screen 200, and cause touch-screen 200 to render one or more images showing notification 404 moving off-screen according to the path.

Continuing with the description of FIG. 8, operation 820 shows that in an embodiment computing device 100 can include circuitry for returning the second notification to an initial position in response to determining both that a center point of the second notification failed to reach the boundary on the touch-screen and determining that the second touch input was removed from the touch-screen. In an exemplary embodiment, when touch input is removed from a notification, notification manager 302 can determine a path for the notification to travel that will move the notification back to its initial position and cause touch-screen 200 to render one or more images of the notification moving back to the initial position according to the path.

For example, and referring to FIG. 4, suppose that the user has selected notification 402 and notification 404 and has moved notification 404 slightly to the right. That is, touch-messages indicating that touch input 204 is changing to the right can be received by notification manager 302, which can cause touch-screen 200 to change the image indicative of notification 404 to the right so that it appears to be moving to the right. In this example, the user may release notification 404 after it has been moved slightly to the right and a touch-message can be received by notification manager 302 that indicates that touch input 204 has been removed. Notification manager 302 can determine that notification 404 was associated with touch input 204 and determine that it has not crossed a dismissal threshold, e.g., the center point of notification 404 has not passed boundary 408. In response to this determination, notification manager 302 can determine a path for notification 404 to travel that will move it back to its initial position and cause touch-screen 200 to render one or more images of notification 404 moving back to the initial position.

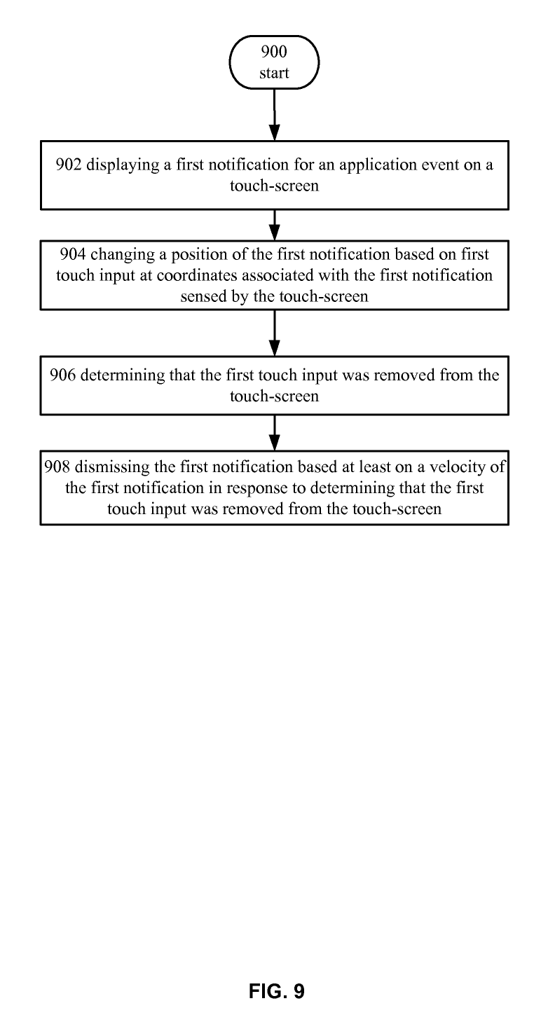

Turning not to FIG. 9, it shows an operational procedure for dismissing notifications displayed by touch-screen 200 including the operations 900, 902, 904, 906, and 908. Operation 900 begins the operational procedure and operation 902 shows displaying a first notification for an application event on a touch-screen. For example, touch-screen 200 can be configured to display a first notification. For example, computing device 100 can include touch-screen 200, which can be configured to sense touch input from, for example, a finger of a user. In this example, computing device 100 can include an event manager 304, which can be configured to receive requests to display notifications from applications such as an instant messenger client. Event manager 304 can receive requests to display notifications and communicate the same to notification manager 302, which can cause touch-screen 200 to render images indicative of at least a first notification.

Continuing with the description of FIG. 9, operation 904 shows that in an embodiment computing device 100 can include circuitry for changing a position of the first notification based on first touch input at coordinates associated with the first notification sensed by the touch-screen. For example, and referring to FIG. 5, in an exemplary embodiment the position of the first notification, e.g., notification 502, can be changed based on touch input, e.g., touch input 202, by notification manager 302 causing touch-screen 200 to render images of the notification being moved along with touch input 202. In this exemplary embodiment, notification manager 302 can be configured to change the position of notification 502 in response to sensed touch input from, for example, a digit of a user. Notification manager 302 can cause the image of notification 502 to change to appear as if it is moving to the right to an updated position, e.g., the dashed element labeled notification 502.

Notification manager 302 can cause the position of an image indicative of notification 502 to be changed based on the position of touch input 202. For example, notification manager 302 can include notification table 312, which can include a column that includes identifiers for each notification it is currently tracking, e.g., an identifier for notification 502, columns that store the coordinates of, for example, the initial position of notification 502 and coordinates of the current position of notification 502, a column that includes an identifier for the touch source associated with notification 502, e.g., an identifier indicating that touch input 202 is associated with notification 502, etc. In a specific example, notification manager 302 can receive a touch-message that include an identifier for touch input 202 and the difference between its current sensed position and a previous sensed position. In this example, notification manager 302 can determine that notification 502 is associated with touch input 202 and update the coordinates of the current position of notification 402 based on the difference and send a signal to touch-screen 200 to cause touch-screen 20 render one or more images of notification 402 moving to the updated position.

Referring to operation 906, it shows that in an embodiment computing device 100 can include circuitry for determining that the first touch input was removed from the touch-screen. For example, after the position of notification 502 has been changed by notification manager 302, a user may lift his or her finger off touch-screen 200 and notification manager 302 can receive a touch-message indicating that touch input, e.g., touch input 202 has been removed. In this example, notification manager 302 can change a bit in table 312 that indicates that the notification, e.g., notification 402 of FIG. 4, has been deselected, i.e., is no longer associated with touch input.

Turning operation 908, it shows that in an embodiment computing device 100 can include circuitry for dismissing the first notification based at least on a velocity of the first notification in response to determining that the first touch input was removed from the touch-screen. For example, notification manager 302 can be configured to use a gesture from gesture store 314 that is based on the velocity of the notification when it is released. In this example, gesture store 314 can include a velocity threshold, e.g., a value, that can be compared to the current velocity of a notification, e.g., 402 when touch input is removed from touch-screen 200 and a direction vector, e.g., to the right. In the instance that the current velocity of the first notification is less than the velocity threshold or the velocity is in the wrong direction, notification manager 302 can cause touch-screen 200 to render one or more images showing the notification returning to its initial position. In the instance that the current velocity of the first notification is greater than the velocity threshold and the velocity is in a direction that matches the direction vector, notification manager 302 can use the current coordinates of the notification and a direction the notification was traveling to determine a path for the notification that moves it off-screen and cause touch-screen 200 to render one or more images showing the notification moving off-screen in accordance with the determined path.

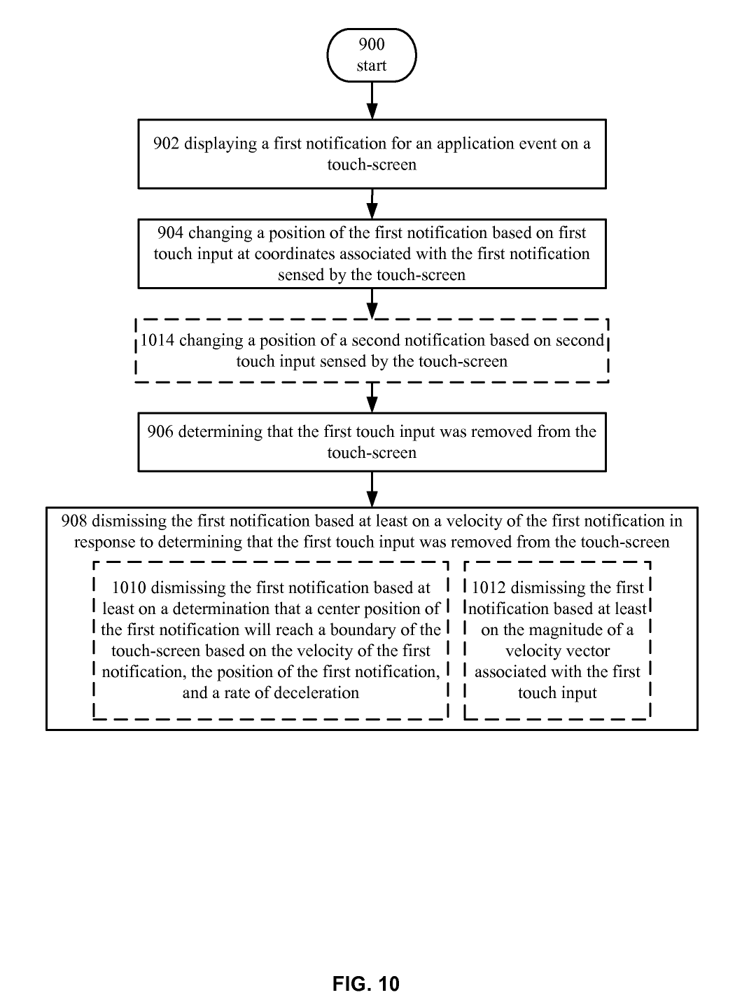

Turning now to FIG. 10, it illustrates alternative operations/refinements that can be performed in conjunction with the operational procedures illustrated by FIG. 9. For example, operation 1010 shows that in an embodiment computing device 100 can include circuitry for dismissing the first notification based at least on a determination that a center position of the first notification will reach a boundary of the touch-screen based on the velocity of the first notification, the position of the first notification, and a rate of deceleration. For example, in an embodiment a notification can be dismissed in the instance that notification manger 302 calculates that a center position of a notification would move off-screen based on the velocity of the notification when touch input it is associated with is removed from touch screen 200, the coordinates of the notification when touch input it removed, and a rate of deceleration. For example, notification manager 302 can calculate the initial velocity of a notification from at least two touch-messages that include the coordinates of the upper-left corner of the notification when touch input was removed, coordinates of the upper-left corner of the notification from a previous sample, and timestamps from the touch-messages. The rate of deceleration in this example can be a constant that can be set by an implementer.

In this example, notification manager 302 can calculate the coordinates at which the velocity would be equal to zero. In this example, if the coordinates of the center point of the notification are beyond the boundary, notification manager 302 can cause touch-screen 200 to render one or more images of the notification moving off-screen. In the instance that coordinates are not passed the boundary, notification manager 302 can cause touch-screen 200 to render one or more images of the notification moving back to its initial position. In this example, the animation could show the notification slowing down and pausing at the coordinates where the final velocity equals zero and then moving back to its initial position. In the instance that coordinates where the velocity would be equal to zero are at the edge, an implementer can either have the notification return to its initial position, have it move off-screen, or have it pause at the edge to allow the user to touch the notification and move it off-screen, e.g., notification manager 302 can have the notification pause to give the user time to give the notification one more push to get it off-screen.

Continuing with the description of FIG. 10, it shows operation 1012 which illustrates that in an embodiment computing device 100 can include circuitry for dismissing the first notification based at least on the magnitude of a velocity vector associated with the first touch input. For example, the magnitude of a velocity vector can be used to calculate the velocity of the notification. For example, and referring to FIG. 5, in an embodiment notification manager 302 may restrict the movement of notification to one dimension, e.g., within the x dimension. Since the user may move his or her finger in more than one dimension, notification manager 302 can use the magnitude of a velocity vector associated with touch input instead of the velocity of the notification as it moves along the x-axis. As shown by FIG. 5, the magnitude of the velocity vector, which is identified by reference numeral 510, is larger than the x-component of the velocity and can be used instead of the x-component of the velocity to determine if a notification should be dismissed. In the same, or an alternative embodiment, notification manager 302 can be configured to use the magnitude in the instance that the angle of the velocity vector is within a predetermined threshold such between positive 45 degrees and negative 45 degrees (measured from the x axis, where 90 degrees and negative −90 degrees would be perpendicular to the x-axis).

Operation 1014 is also shown by FIG. 10. This operation illustrates that in an exemplary embodiment computing device 100 can include circuitry for changing a position of a second notification based on second touch input sensed by the touch-screen. For example, and referring to FIG. 5, in an exemplary embodiment the position, e.g., the coordinates of the upper-left corner, of a second notification, e.g., notification 504, can be changed by notification manager 302 based on second touch input, e.g., touch input 204, that is sensed by touch-screen 200. In this exemplary embodiment, notification manager 302 can be configured to change the coordinates associated with the upper-left corner of notification 504 in response to sensed touch input from, for example, a second digit of a user.

In a specific example, suppose that the user places a first finger on touch-screen 200 and then places a second finger on touch-screen 200 within coordinates associated with notification 504. In this specific example, notification manager 302 can receive a touch-message that include an identifier for touch input 204 and coordinates. Notification manager 302 can determine that the coordinates are within notification 504 and store information in table 312 that indicates that notification 504 has been selected by touch input 204. The user may move his or her second finger and notification manager 302 can receive touch-messages indicating the difference between a previous position of touch input 204 and an updated position and use the difference to change the pixel values for the upper-left corner of notification 504 to give the appearance that the user is moving notification 504.

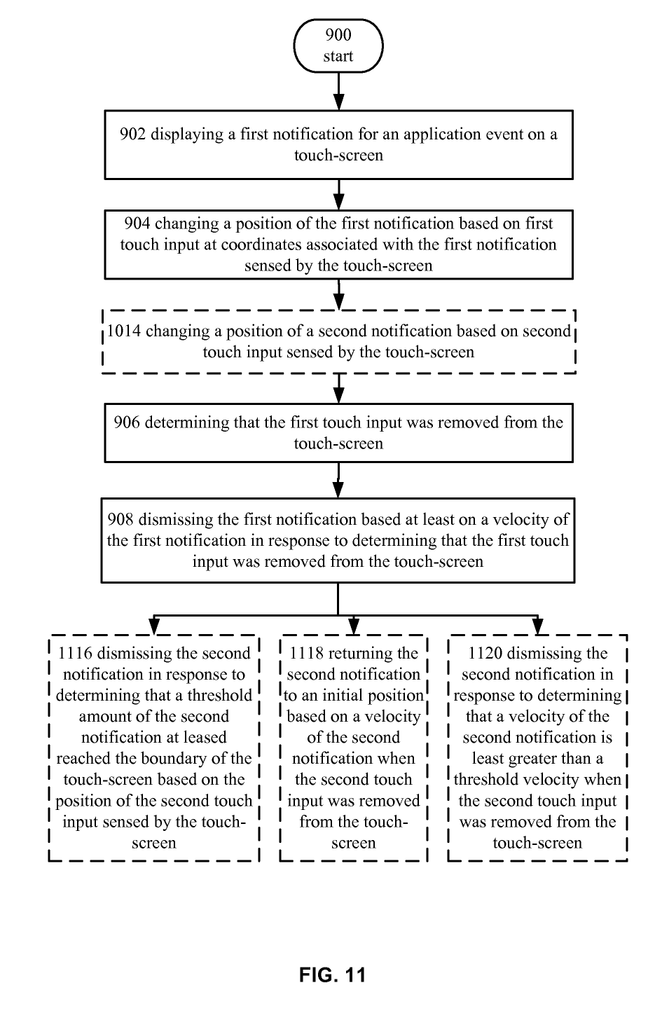

Turning now to FIG. 11, it shows another set of exemplary operations that can be performed in conjunction with at least operation 1014 of FIG. 10. As shown by the figure, operation 1116 illustrates that in an exemplary embodiment, computing device 100 can include circuitry for returning the second notification to an initial position based on a velocity of the second notification when the second touch input was removed from the touch-screen. In an exemplary embodiment, when a notification is released and it is moving slower than the dismissal velocity associated with a dismissal gesture, notification manager 302 can be configured to cause touch-screen 200 to render one or more images that shows the notification returning to its initial position. In this example, the dismissal gesture can be based on the velocity of the notification when it is released by the user, e.g., when touch input is removed from touch-screen 200.

For example, and referring to FIG. 5, suppose that the user has selected notification 502 and notification 504 and has moved notification 504 slowly to the right. That is, touch-messages indicating that touch input 204 is moving to the right can be received by notification manager 302, which can determine from the messages to cause touch-screen 200 to change the position of notification 504 to make it appear to move slowly to the right. In this example, the user may release notification 504 and a touch-message can be received by notification manager 302 that indicates that touch input 204 has been removed. Notification manager 302 can deselect notification 504 and determine that its velocity is lower than a threshold. In response to this determination, notification manager 302 can cause touch-screen 200 to render one or more images of notification 504 moving back to its initial position.

Continuing with the description of FIG. 11, operation 1118 shows dismissing the second notification in response to determining that a velocity of the second notification is least greater than a threshold velocity when the second touch input was removed from the touch-screen. In an exemplary embodiment, the release velocity of the notification can be used to determine if a dismissal gesture was performed. In this example, when touch input is removed from touch-screen 200, notification manager 302 can determine the velocity of the second notification and compare the velocity of the second notification to a threshold. In the instance that the velocity is greater than the velocity threshold, notification manager 302 can be configured to dismiss the notification associated with touch input 202. For example, notification manager 302 can determine a path for the notifications that would move the notifications off-screen, e.g., off the right side of touch-screen 200, and cause touch-screen 200 to render one or more images showing notifications in the group moving off-screen according to the path.

In a specific example, and referring to FIG. 5, notification 502 may be selected and the user may move his or her finger towards the right edge of touch-screen 200 making a “flicking motion,” and remove his or her finger from touch-screen 200. In response, touch-manager 208 can receive one or more signals from capacitive layer 212 of touch-screen 200 indicating that touch input 202 made a quick motion and then ended. Touch-manager 208 can process this information and generate one or more touch-messages and send them to touch manager 302. Touch manager 302 can determine the velocity of touch input 204 by using the change in position between two points, e.g., from coordinates associated with the last two touch-messages for touch input 204, and timestamps. Notification manager 302 can compare the calculated velocity to the threshold and determine if the calculated velocity is higher. In the instance it is higher, notification manager 302 can dismiss notification 504.

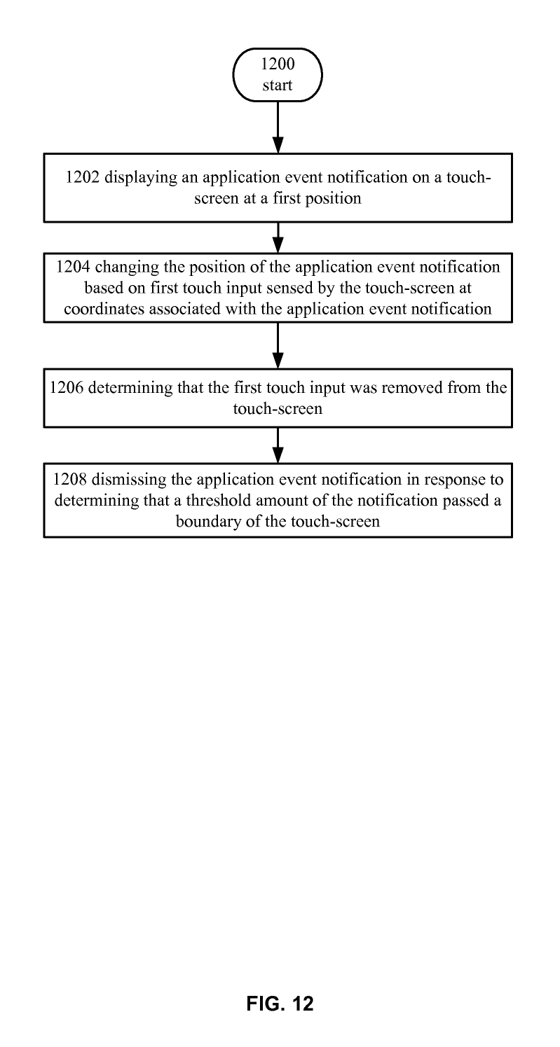

Turning now to FIG. 12, it shows an operational procedure for dismissing notifications displayed by a touch screen such as touch screen 200 including operations 1200, 1202, 1204, 1206, and 1208. Operation 1200 begins the operational procedure, and operation 1202 shows an operation for displaying an application event notification on a touch-screen at a first position. For example, touch-screen 200 can be configured to display a first notification. For example, computing device 100 can include touch-screen 200, which can be configured to sense touch input from, for example, a finger of a user. In this example, computing device 100 can include an event manager 304, which can be configured to receive requests to display notifications from applications such as an instant messenger client. Event manager 304 can receive requests to display notifications and communicate the same to notification manager 302, which can cause touch-screen 200 to render images indicative of at least a first notification.

Continuing with the description of FIG. 12, operation 1204 shows changing the position of the application event notification based on first touch input sensed by the touch-screen at coordinates associated with the application event notification. For example, and referring to FIG. 4, in an exemplary embodiment the position of the first notification, e.g., notification 402, can be changed based on touch input, e.g., touch input 202, by notification manager 302 causing touch-screen 200 to render images of the notification being moved along with touch input 202. In this exemplary embodiment, notification manager 302 can be configured to change the position of notification 402 in response to sensed touch input from, for example, a digit of a user. Notification manager 302 can cause the image of notification 502 to change to appear as if it is moving up and to the right to an updated position.

Notification manager 302 can cause the position of an image indicative of notification 402 to be changed based on the position where touch input 202 is sensed. For example, notification manager 302 can include notification table 312, which can include a column that includes identifiers for each notification it is currently tracking, e.g., an identifier for notification 402, columns that store the coordinates of, for example, the initial position of notification 502 and coordinates of the current position of notification 402, a column that includes an identifier for the touch source associated with notification 402, e.g., an identifier indicating that touch input 202 is associated with notification 402, etc. In this specific example, notification manager 302 can receive a touch-message that includes an identifier for touch input 202 and the difference between its current sensed position and a previous sensed position. In this example, notification manager 302 can determine that notification 402 is associated with touch input 202 and update the coordinates of the current position of notification 402 based on the difference and send a signal to touch-screen 200 to cause touch-screen 200 render one or more images of notification 402 moving to the updated position.

Turning now to operation 1206, it shows determining that the first touch input was removed from the touch-screen. For example, after the position of notification 502 has been changed by notification manager 302, a user may lift his or her finger off touch-screen 200 and notification manager 302 can receive a touch-message indicating that touch input, e.g., touch input 202 has been removed. In this example, notification manager 302 can change a bit in table 312 that indicates that the notification, e.g., notification 502 of FIG. 5, has been deselected, i.e., is no longer associated with touch input 202.

Continuing with the description of FIG. 12, operation 1208 dismissing the application event notification in response to determining that a threshold amount of the notification passed a boundary of the touch-screen. In an exemplary embodiment, the amount of the first notification that has been moved passed a boundary can be used to determine if a dismissal gesture was performed. For example, gesture store 314 can include a value indicative of the amount of a notification as a dismissal threshold. In this example, when touch input is removed from touch-screen 200, notification manager 302 can determine how much of the first notification has been moved passed the boundary and compare the amount to the threshold. In the instance that the amount of the first notification that is passed the boundary is greater than the threshold, then notification manager 302 can be configured to dismiss the notification. For example, notification manager 302 can determine a path for the notification that would move the notification off-screen, e.g., off the right side of touch-screen 200, and cause touch-screen 200 to render one or more images showing the notification moving off-screen according to the path.

In a specific example, and referring to FIG. 4, suppose notification manager 302 has changed the position of notification 406 to move a part of it passed a boundary, which could be the last x-coordinate on touch-screen 200, e.g., pixel value 768. That is, touch-messages indicating that touch input 202 has moved up and to the right can be received by notification manager 302, which can cause touch-screen 200 to change the position of notification 402 to make it appear to move up and to the right. In this example, the user may release notification 402 and a touch-message can be received by notification manager 302 that indicates that touch input 202 has been removed. Notification manager 302 can deselect notification 402 and compare that the part of notification 402 that has moved passed pixel 768 to a threshold. In response to this determination, notification manager 302 can cause touch-screen 200 to dismiss notification 402.

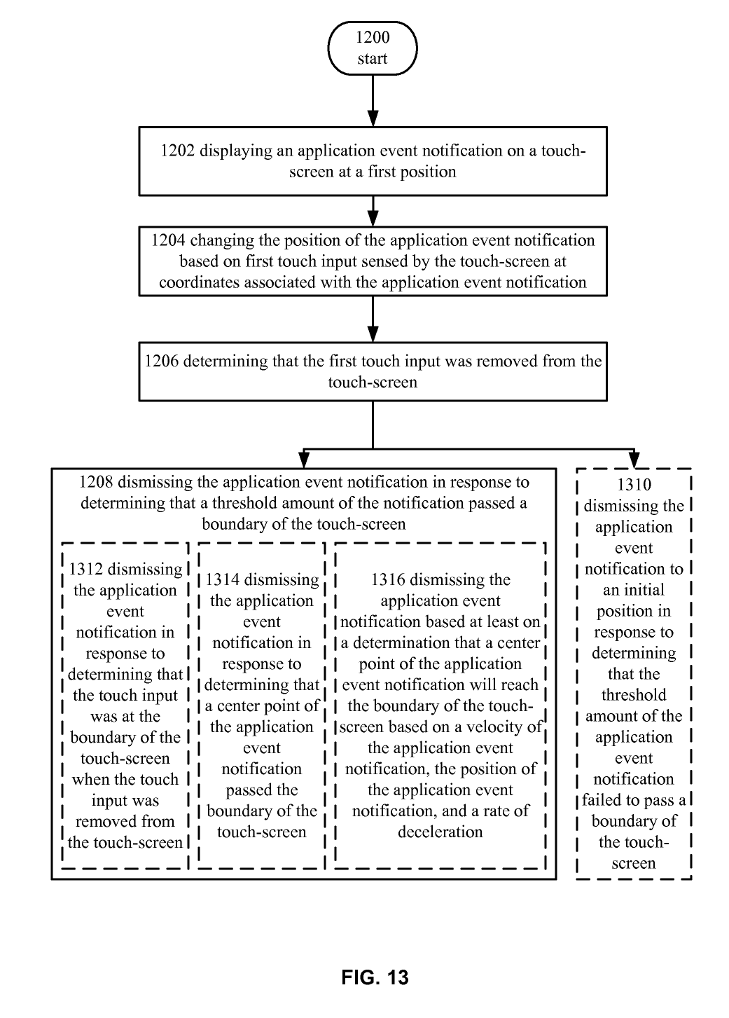

Turning now to FIG. 13, it shows alternative operations that can be executed along with the exemplary operations described above with respect to FIG. 12. Operation 1310 shows returning the application event notification to an initial position in response to determining that the threshold amount of the application event notification failed to pass a boundary of the touch-screen. In an exemplary embodiment, when a notification, e.g., notification 502, is released and the threshold amount of notification 502 has not been moved off-screen, notification manager 302 can be configured to cause touch-screen 200 to render one or more images of the notification moving back to its initial position.

For example, and referring to FIG. 5, suppose that the user has selected notification 502 and notification manager 302 has changed the position of notification 502 to move a part of it off-screen. That is, touch-messages indicating that touch input 202 is moving to the right can be received by notification manager 302, which can cause touch-screen 200 to change the position of notification 502 to make it appear to move to the right matching the speed of touch input 202. In this example, the user may release notification 502 and a touch-message can be received by notification manager 302 that indicates that touch input 202 has been removed. Notification manager 302 can deselect notification 502 and determine that the part of notification 502 that has moved off-screen is less than a threshold, e.g., less than 25%. In response to this determination, notification manager 302 can cause touch-screen 200 to render one or more images showing notification 502 moving back to its initial position.

Continuing with the description of FIG. 13, operation 1312 shows dismissing the application event notification in response to determining that the touch input was at the boundary of the touch-screen when the touch input was removed from the touch-screen. For example, notification manager 302 can be configured to dismiss notifications in the instance that touch input associated with the notifications was sensed at or passed boundary 408 of touch-screen 200 when the touch input was removed his or her finger from touch-screen 200.

For example, and referring to FIG. 4, notification manager 302 may have stored information in notification table 312 that indicates that notification 402 has been selected by touch input 202. For example, the user may have placed his or her finger on touch-screen 200 within coordinates associated with notification 402 and dragged his or her toward the right side of touch-screen 200. In this example, the user may move his or her finger to and/or passed a boundary, which could be set to the last y-pixel for touch-screen 200, e.g., pixel value 1024 (in an embodiment where touch-screen has 768×1024 pixels). The user may then remove his or her finger from touch-screen 200 and notification manager 302 may receive a touch-message that indicates that touch input 202 has been removed from touch-screen 200. In this example, notification manager 302 can access table 312 and obtain coordinates for touch input 202 from a prior sample and determine that the y-coordinate of touch input 202 is equal to or greater than the y-coordinate of the boundary, which could be obtained from gesture store 314. In response to this determination, notification manager 302 can check notification table 312 to determine if any notifications were associated with touch input 202. Notification manager 302 can determine that notification 402 is associated with touch input 202 and dismiss notification 402 by determining a path for notification 402 to travel off-screen and causing touch-screen 200 to render one or more images of notification 402 moving off-screen in accordance with the determined path.

Referring back to FIG. 13, operation 1312 shows dismissing the application event notification in response to determining that a center point of the application event notification passed the boundary of the touch-screen. In an exemplary embodiment, a center point of the notification can be compared to the boundary to determine whether or not to dismiss the notification. In the instance that the center point is at and/or has crossed the boundary, notification manager 302 can be configured to dismiss the notification.

For example, notification manager 302 can receive a message that indicates that touch input 202 was removed from touch-screen 200 and determine that touch input 202 was associated with notification 402. In response to this determination, notification manager 302 can determine that a center point of notification 402, e.g., a center point calculated from x, y coordinates of the upper-left corner of notification 402 and x, y coordinates of the lower-right corner of notification 402, compare the center point of notification 402 to a boundary, e.g., a pixel value which could be an x, y, coordinate pair, an x coordinate, or a y coordinate, and determine if the center point has moved to or passed the boundary. In the instance that the center point of notification 402 has at least reached the center point, notification manager 302 can be configured to dismiss notification 402 by determining a path for notification 402 to travel to move off-screen and causing touch-screen 200 to render one or more images of notification 402 moving off-screen according to the path.

In a specific example embodiment, and referring to FIG. 5, suppose notification manager 302 has limited the motion of notifications to moving in the horizontal direction, i.e., within the x-axis. When touch input is removed from notification 502, notification manager 302 can determine a location of a horizontal center point, which could be calculated from the current position of upper-left corner x-coordinate and the current position of the x-coordinate associated with the lower-right corner and the determined location of the center point can be compared to an x-coordinate of a boundary, which could be the edge of touch-screen 200. In the illustrated example, the horizontal center point of notification 502 can be determined to have passed the boundary. In response to this determination, notification manager 302 can be configured to dismiss notification 502 by determining a path for notification 502 to travel to move off-screen and causing touch-screen 200 to render one or more images of notification 502 moving off-screen according to the path.

Referring back to FIG. 13, operation 1314 shows dismissing the application event notification based at least on a determination that a center point of the application event notification will reach the boundary of the touch-screen based on a velocity of the application event notification, the position of the application event notification, and a rate of deceleration. For example, in an embodiment a notification can be dismissed in the instance that notification manger 302 calculates that the notification would move off-screen based on the velocity of the notification when touch input it is associated with is removed from touch screen 200, the coordinates of the notification when touch input it removed, and a rate of deceleration. For example, notification manager 302 can calculate the initial velocity of a notification from at least two touch-messages that include the coordinates of the upper-left corner of the notification when touch input was removed, coordinates of the upper-left corner of the notification from a previous sample, and timestamps from the touch-messages. The rate of deceleration in this example can be a constant that can be set by an implementer.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computing device, comprising:
a processor;
a touch-screen; and
a memory in operable communication with the processor and the touch-screen, the memory including instructions that upon execution by the processor cause the processor to:
display a first notification, wherein the first notification is visually decoupled from graphical user interface elements rendered by the touch-screen;
display the first notification moving on the touch-screen based on first touch input sensed by the touch screen at coordinates associated with the first notification; and
dismiss the first notification in response to determining that a threshold amount of the notification at least reached a boundary on the touch-screen and that the first touch input was removed from the touch-screen.

2. The computing device of claim 1, wherein the instructions that upon execution cause the processor to dismiss the first notification further comprise instructions that upon execution cause the processor to:
dismiss the first notification in response to determining that a center point of the first notification at least reached the boundary on the touch-screen.

3. The computing device of claim 1, wherein the instructions that upon execution cause the processor to dismiss the first notification further comprise instructions that upon execution cause the processor to:
dismiss the first notification in response to determining a position of the first sensed touch input at least reached a boundary on the touch-screen.

4. The computing device of claim 1, wherein the instructions that upon execution cause the processor to dismiss the first notification further comprise instructions that upon execution cause the processor to:
dismiss the first notification in response to determining that the first notification will move off the touch-screen based on the velocity of the first notification, the position of the first notification, and a rate of deceleration.

5. The computing device of claim 1, wherein the instructions that upon execution cause the processor to dismiss the first notification further comprise instructions that upon execution cause the processor to:
dismiss the first notification in response to determining that the velocity of the first notification when the first touch input was removed from the touch-screen is greater than a velocity threshold.

6. The computing device of claim 1, wherein the memory further comprises instructions that upon execution by the processor cause the processor to:
select both the first notification based on first touch input sensed by the touch-screen and a second notification based on second touch input sensed by the touch-screen.

7. The computing device of claim 6, further comprising:
dismiss the second notification in response to determining that a threshold amount of the second notification at least reached the boundary of the touch-screen based on the position of the second touch input sensed by the touch-screen.

8. The computing device of claim 6, further comprising:
return the second notification to an initial position in response to determining both that a center point of the second notification failed to reach the boundary on the touch-screen and determining that the second touch input was removed from the touch-screen.

9. A method for dismissing notifications displayed by a touch-screen, comprising:
displaying a first notification for an application event on a touch-screen;
changing a position of the first notification based on first touch input at coordinates associated with the first notification sensed by the touch-screen;
determining that the first touch input was removed from the touch-screen; and
dismissing the first notification based at least on a velocity of the first notification in response to determining that the first touch input was removed from the touch-screen.

10. The method of claim 9, wherein dismissing the first notification based at least on the velocity further comprises:
dismissing the first notification based at least on a determination that a center position of the first notification will reach a boundary of the touch-screen based on the velocity of the first notification, the position of the first notification, and a rate of deceleration.

11. The method of claim 9, wherein dismissing the first notification based at least on the velocity further comprises:
dismissing the first notification based at least on the magnitude of a velocity vector associated with the first touch input.

12. The method of claim 9, further comprising:
changing a position of a second notification based on second touch input sensed by the touch-screen.

13. The method of claim 12, further comprising:
dismissing the second notification in response to determining that a threshold amount of the second notification at leased reached the boundary of the touch-screen based on the position of the second touch input sensed by the touch-screen.

14. The method of claim 12, further comprising:
returning the second notification to an initial position based on a velocity of the second notification when the second touch input was removed from the touch-screen.

15. The method of claim 12, further comprising:
dismissing the second notification in response to determining that a velocity of the second notification is least greater than a threshold velocity when the second touch input was removed from the touch-screen.

16. A computer-readable storage medium including instructions for dismissing notifications displayed by a touch-screen, the computer-readable storage medium including instructions that upon execution cause a processor to:
display an application event notification on a touch-screen at a first position;
change the position of the application event notification based on first touch input sensed by the touch-screen at coordinates associated with the application event notification;
determine that the first touch input was removed from the touch-screen; and
dismiss the application event notification in response to determining that a threshold amount of the notification passed a boundary of the touch-screen.

17. The computer-readable storage medium of claim 16, further comprising instructions that cause the processor to:
return the application event notification to an initial position in response to determining that the threshold amount of the application event notification failed to pass a boundary of the touch-screen.

18. The computer-readable storage medium of claim 16, further comprising instructions that cause the processor to:
dismiss the application event notification in response to determining that the touch input was at the boundary of the touch-screen when the touch input was removed from the touch-screen.

19. The computer-readable storage medium of claim 16, wherein the instructions that upon execution cause the processor to dismiss the application event notification further comprise instructions that cause the processor to:
dismiss the application event notification in response to determining that a center point of the application event notification passed the boundary of the touch-screen.

20. The computer-readable storage medium of claim 16, wherein the instructions that cause the processor to dismiss the application event notification further comprise instructions that cause the processor to:
dismiss the application event notification based at least on a determination that a center point of the application event notification will reach the boundary of the touch-screen based on a velocity of the application event notification, the position of the application event notification, and a rate of deceleration.
